(19) United States
(12) Patent Application Publication
(10) Pub. No.: US 2025/0387938 A1
(43) Pub. Date: Dec. 25, 2025

(54) CUTTING DEVICE, CUTTING METHOD, AND RECORDING MEDIUM

(71) Applicant: CASIO COMPUTER CO., LTD., Tokyo (JP)

(72) Inventor: Satoshi KIMURA, Tokyo (JP)

(73) Assignee: CASIO COMPUTER CO., LTD., Tokyo (JP)

(21) Appl. No.: 19/244,019

(22) Filed: Jun. 20, 2025

(30) Foreign Application Priority Data
Jun. 21, 2024 (JP) 2024-100085

(51) Int. Cl. B26D 5/00; B26D 5/06; B26F 1/38

(52) U.S. Cl. CPC B26D 5/005; B26D 5/06; B26F 1/3813

(57) ABSTRACT

A cutting device includes: a holding member which holds a sheet-shaped object to be cut; a cutter which cuts the object to be cut by changing the position of a blade relative to the object to be cut along the object to be cut in such a state that the blade is cut into the object to be cut; a pressing force applying unit which applies a pressing force to the cutter in contact with the object to be cut; a relative position changing unit which changes the position of the blade of the cutter relative to the object to be cut held by the holding member; and a processor which controls the pressing force applying unit to reduce the pressing force applied to the cutter by the pressing force applying unit along with a change in the position of the blade of the cutter relative to the object to be cut by a predetermined distance or for a predetermined time after the pressing force is applied to the cutter.

### CROSS-REFERENCE TO RELATED APPLICATION

This application is based upon and claims the benefit of priority from Japanese Patent Application No. 2024-100085, filed on Jun. 21, 2024, the entire contents of which are incorporated herein by reference.

### BACKGROUND OF THE INVENTION

### 1. Field of the Invention

The present invention relates to a cutting device, a cutting method, and a recording medium.

### 2. Related Art

Among cutting devices for cutting a sheet-shaped object to be cut (workpiece), there is a cutting device for cutting out a desired shape from the object to be cut by moving a blade of a cutter relative to the object to be cut in such a state that a blade edge of the cutter to cut the object to be cut is pressed against the object to be cut. As this type of cutting device, there is a cutting device which changes the pressure of the cutter against the object to be cut according to the relative movement direction between the object to be cut and the cutter (For example, Japanese Unexamined Patent Application Publication No. 2014-008557).

### SUMMARY OF THE INVENTION

A cutting device according to one aspect of the present invention includes: a holding member which holds a sheet-shaped object to be cut; a cutter which cuts the object to be cut by changing the position of a blade relative to the object to be cut along the object to be cut in such a state that the blade is cut into the object to be cut; a pressing force applying unit which applies a pressing force to the cutter in contact with the object to be cut; a relative position changing unit which changes the position of the blade of the cutter relative to the object to be cut held by the holding member; and a processor which controls the pressing force applying unit to reduce the pressing force applied to the cutter by the pressing force applying unit along with a change in the position of the blade of the cutter relative to the object to be cut by a predetermined distance or for a predetermined time after the pressing force is applied to the cutter.

According to the above aspect, the occurrence of a cutting defect at the start of cutting in a cutting device that cuts a sheet-shaped object to be cut by a cutter can be prevented.

### BRIEF DESCRIPTION OF THE DRAWINGS

FIG. 1 is a diagram for describing a configuration example of a cutting device according to one embodiment.

FIG. 2 is a block diagram for describing a functional configuration example of the cutting device.

FIG. 3A and FIG. 3B are views for describing a pressing force applied to a cutter.

FIG. 4 is a view for describing an example of the operation of the cutting device according to the embodiment.

FIG. 5A is a table illustrating an example of control parameters.

FIG. 5B and FIG. 5C are views illustrating an example of a cutting method of a multi-layered object to be cut.

FIG. 6 is a flowchart for describing an example of processing performed by the cutting device according to the embodiment.

FIG. 7 is a graph for describing a graph for describing an example of a control method of the pressing force applied to the cutter.

### DESCRIPTION OF THE PREFERRED EMBODIMENT

An embodiment of the present invention will be described below with reference to the accompanying drawings. X axis, Y axis, and Z axis in the drawings to be referred to are illustrated for the purpose of identifying planar and directional relationships of same components illustrated in different drawings. It is assumed that the X axis, Y axis, and Z axis are perpendicular to one another to form a right-handed system. In the following description, a direction parallel to the X axis is called the X direction, a direction parallel to the Y axis is called the Y direction, and a direction parallel to the Z axis is called the Z direction. Further, when each of the X direction, the Y direction, and the Z direction is associated with an arrow (positive and negative) direction of each of the illustrated X axis, Y axis, and Z axis, “+” or “−,” or “positive side” or “negative side” is attached to each of the X direction, the Y direction, and the Z direction, respectively. For example, “+X direction” and “−X direction” mean the arrow direction indicative of the X axis and the direction opposite to the arrow direction, respectively. Further, “X-direction positive side” means a side in the +X direction when viewed from a surface, a member, a position, or the like as a reference, and “X-direction negative side” means a side in the −X direction when viewed from a surface, a member, a position, or the like as a reference.

In this specification, the Z direction may also be referred to as the up-and-down direction. In this specification, “up” or “upward” means a side in the Z direction more positive than a surface, a member, a position, or the like as a reference, and “down” or “downward” means a side in the Z direction more negative than a surface, a member, a position, or the like as a reference. For example, when it is written as “member B is placed on member A,” the member B is placed on the Z-direction positive side as viewed from the member A. Further, when it is written as “top surface of member A,” the surface is located on the edge of the Z-direction positive side in the member A, which contains a surface facing the Z-direction positive side. The names of these directions and surfaces associated with the directions are used merely for convenience of description, and the correspondences of an illustrated cutting device with the X axis, Y axis, and Z axis directions may change depending on the installation posture of the cutting device, and the like. For example, in this specification, the surface called the “top surface” may also be called a “bottom surface” or a “side surface,” and the names of the other surfaces may be changed accordingly.

Further, in this specification and drawings to be referred to, plural same components to which the same numerical sign is assigned are distinguished from one another by alphabet letters following the numerical sign. In this specification, the plural same components distinguished by the alphabet letters in the signs may be distinguished by writing a “first . . . ,” a “second . . . ,” and so on. These written contents are intended solely for the purpose of distinguishing the plural same components, and a component prefaced as a “first . . . ” in this specification may be called a “second” component. Further, in this specification, when mentioning matters common to the plural same components, the alphabet letters in the signs, and the written contents such as “first . . . ,” “second . . . ,” and so on are omitted.

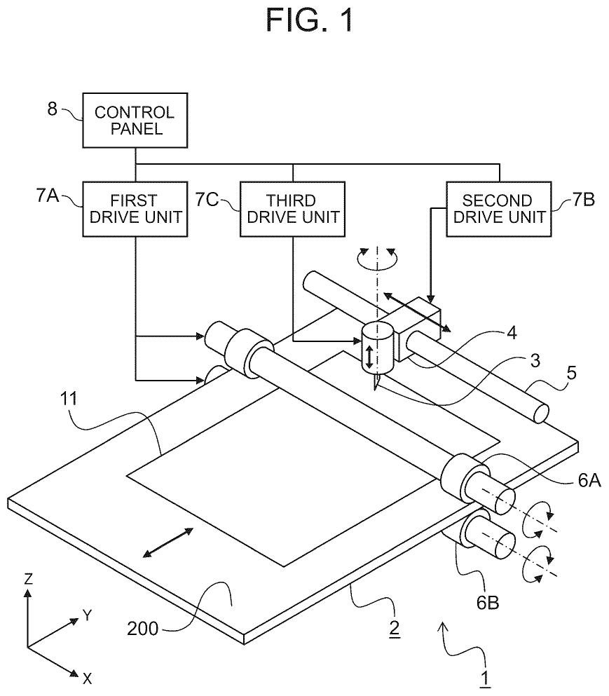

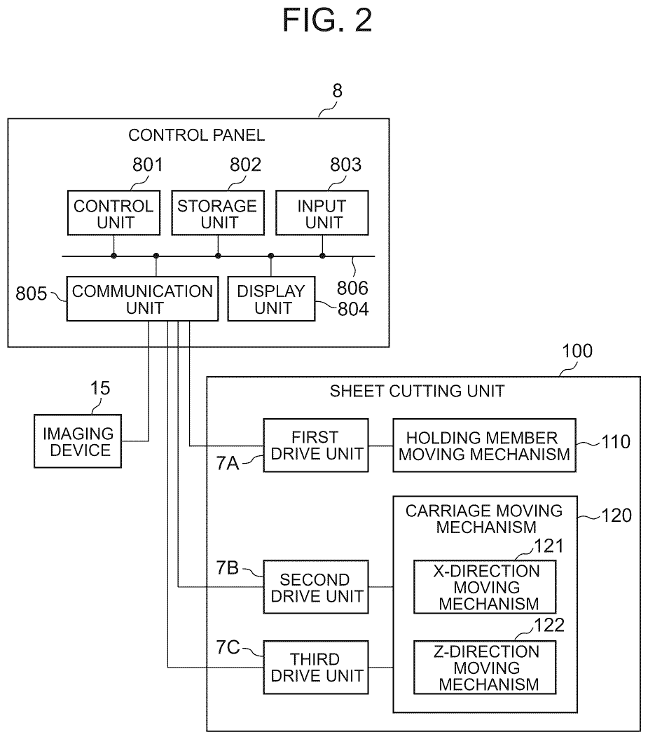

A cutting device 1 illustrated in FIG. 1 includes a holding member 2, a cutter 3, a carriage 4, a carriage support member 5, conveyor rollers 6A and 6B, drive units 7A, 7B, and 7C, and a control panel 8. From another point of view, the cutting device 1 can include a sheet cutting unit 100 and the control panel 8 for controlling the operation of the sheet cutting unit 100 as illustrated in FIG. 2. The sheet cutting unit 100 includes the drive units 7A, 7B, and 7C, a holding member moving mechanism 110, and a carriage moving mechanism 120, and the carriage moving mechanism 120 includes an X-direction moving mechanism 121 and a Z-direction moving mechanism 122. Note that in the sheet cutting unit 100 illustrated in FIG. 2, the holding member 2 and the carriage 4 including the cutter 3 illustrated in FIG. 1 are omitted.

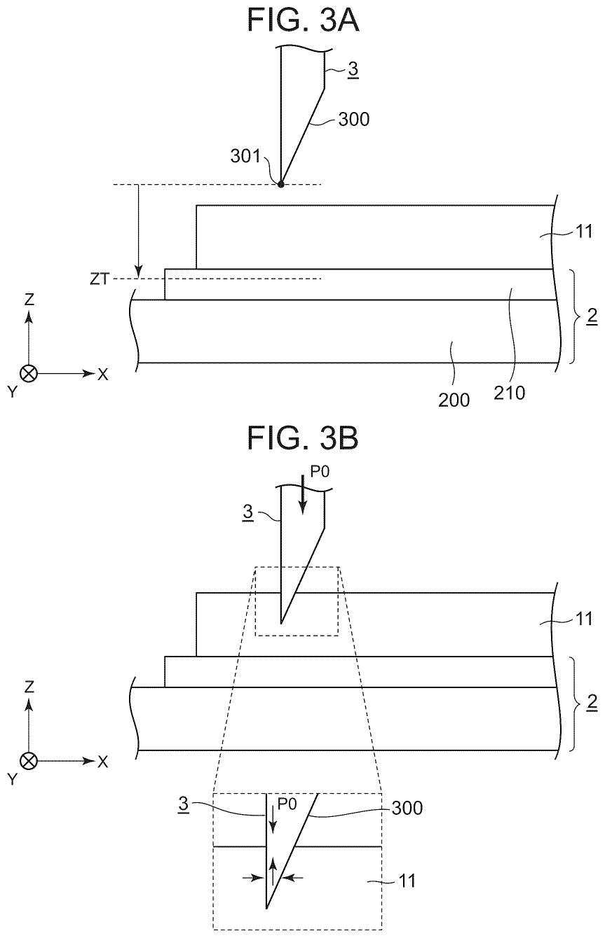

The holding member 2 is a member for holding a sheet-shaped object 11 to be cut (workpiece), which includes a plate-shaped member 200 sometimes called a mount, and an adhesive layer 210 placed on the top surface of the plate-shaped member 200 (see FIG. 3A). The adhesive layer 210 can be an example of a fixing member to prevent the position of the object 11 to be cut on the top surface of the plate-shaped member 200 from shifting. The plate-shaped member 200 of the holding member 2 has clamped sections, clamped by the conveyor rollers 6A and 6B, outside an area in which the object 11 to be cut is placed in a plan view of the top surface of the plate-shaped member 200. The plate-shaped member 200 illustrated in FIG. 1 has the clamped sections, provided on an X-direction positive edge side and an X-direction negative edge side, respectively, to extend along the Y direction. The first conveyor roller 6A is in contact with the top surfaces of the clamped sections in the plate-shaped member 200 and rotates using, as a fulcrum of rotation, the axis of rotation parallel to the X direction. The second conveyor roller 6B is in contact with the bottom surfaces of the clamped sections in the plate-shaped member 200 and rotates using, as the fulcrum of rotation, the axis of rotation parallel to the X direction. The first conveyor roller 6A and the second conveyor roller 6B are included in the holding member moving mechanism 110 of the sheet cutting unit 100 illustrated in FIG. 2. The holding member moving mechanism 110 is a mechanism to move the holding member 2 in the Y direction, which is configured to drive the first conveyor roller 6A and the second conveyor roller 6B to rotate in directions opposite to each other by the power of a first drive unit (for example, a DC motor) 7A. The holding member moving mechanism 110 can be any of known mechanisms, and is not limited to a specific mechanism.

The cutter 3 is a cutting unit to cut the object 11 to be cut by changing the position of a blade 300 (see FIG. 3A and FIG. 3B), cut into the object 11 to be cut, relative to the object 11 to be cut. The cutter 3 is attached to the carriage 4 in such a manner that the direction of the blade 300 when cutting the object 11 to be cut can be changed based on cutting data. The carriage 4 is supported by the carriage support member 5 in such a manner that the cutter 3 can be moved in the X direction. The carriage support member 5 in the cutting device 1 illustrated in FIG. 1 is a rod-shaped member with a circular cross-section (cylindrical member) which is sometimes called a round bar, and the axial core thereof is arranged to extend in the X direction. The carriage 4 of the illustrated cutting device 1 is supported by the carriage support member 5 to be able to rotate, for example, using the axial core (X axis) of the carriage support member 5 as the fulcrum of rotation. In other words, the cutter 3 in the illustrated cutting device 1 can be rotated using the axial core (X axis) of the carriage support member 5 as the fulcrum of rotation, and moved between a position for cutting the object 11 to be cut (a position cut into the object 11 to be cut), and a position away from the object 11 to be cut.

The carriage 4 is coupled to the X direction moving mechanism 121 and the Z direction moving mechanism 122 of the carriage moving mechanism 120 illustrated in FIG. 2. The X-direction moving mechanism 121 is configured to move the carriage 4 by the power of a second drive unit (for example, a DC motor) 7B. The Z-direction moving mechanism 122 is configured to move a blade edge 301 (see FIG. 3A) of the cutter 3 in the Z direction by the power of a third drive unit (for example, a DC motor) 7C. The Z-direction moving mechanism 122 in the cutting device 1 illustrated in FIG. 1 is configured to change the position of the blade edge of the cutter 3 in the Z direction by rotating the cutter 3 using the axial core of the carriage support member 5 as the fulcrum of rotation as described above. The X-direction moving mechanism 121 and the Z-direction moving mechanism 122 can be any of known mechanisms, and are not limited to specific mechanisms. For example, the Z-direction moving mechanism 122 may be a mechanism to move a part of or the entire carriage 4 in a direction parallel to the Z direction in order to move the blade edge 301 of the cutter 3 along the Z direction (that is, a direction parallel to the Z direction).

The first drive unit 7A and the holding member moving mechanism 110, and the second drive unit 7B and the X-direction moving mechanism 121 in the cutting device 1 described above are exemplified as a relative position changing unit to change the position of the blade 300 of the cutter 3 relative to the object 11 to be cut held by the holding member 2. For example, the cutting device 1 may also be configured to be able to change the position of the blade 300 of the cutter 3 relative to the object 11 to be cut even without including the holding member moving mechanism 110 by making the carriage moving mechanism 120 a mechanism capable of moving in the Y direction. In any other example, the cutting device 1 may be configured to make the holding member 2 rotatable inside the XY plane. Further, the third drive unit 7C and the Z-direction moving mechanism 122 in the cutting device 1 described above are exemplified as a pressing force applying unit to apply a pressing force to the cutter 3 in contact with the object 11 to be cut.

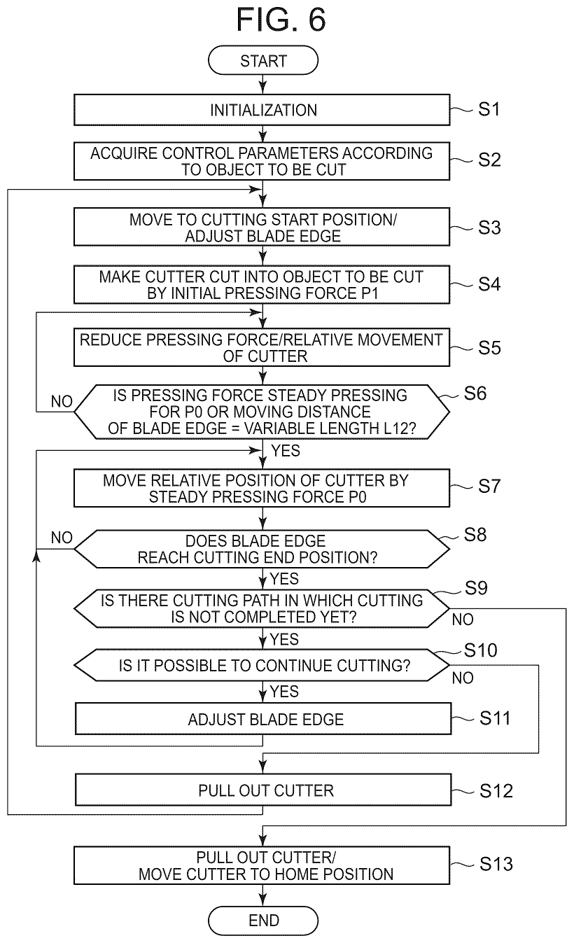

The operation of the cutting device 1 illustrated in FIG. 1 and FIG. 2 is controlled by the control panel 8. As illustrated in FIG. 2, the control panel 8 includes a processor 801, a storage unit 802, an input unit 803, a display unit 804, and a communication unit 805, and these components are connected to one another through a bus 806. The processor 801 controls the operation of the sheet cutting unit 100 by executing a control program containing processes to be described later with reference to FIG. 6 and the like. The functionality of the processor 801 is provided by a processor such as a CPU (Central Processing Unit) or the like that executes the control program stored in the storage unit 802 as a non-transitory computer readable storage medium. The storage unit 802 stores the control program for controlling the operation of the sheet cutting unit 100, cutting data containing information about a cutting path set for the object 11 to be cut, and the like. The functionality of the storage unit 802 can be provided by a ROM (Read Only Memory) and a RAM (Random Access Memory) as main storage devices. The storage devices that provide the functionality of the storage unit 802 may also include an auxiliary storage device such as an HDD (Hard Disk Drive), an SSD (Solid State Drive), or the like. The input unit 803 accepts operations to input and select control parameters for the operation of the sheet cutting unit 100. The display unit 804 visualizes and displays information indicative of the control parameters for the operation of the sheet cutting unit 100 and the operating state thereof. The functions of the input unit 803 and the display unit 804 are provided, for example, by an operation panel in which input devices, such as a switch, a keyboard, and the like, and a display device such as a liquid crystal display are integrated. The operation panel may also have a touch panel display including both the function as the input unit 803 and the function as the display unit 804. The communication unit 805 performs wired or wireless communication with the sheet cutting unit 100 to acquire the operating state of the sheet cutting unit 100, to transmit the control signal or the like to the sheet cutting unit 100, and the like. The communication unit 805 may also be configured to be able to communicate with an imaging device 15 for capturing an image, for example, indicative of the cutting path set for the object 11 to be cut to acquire the image captured by the imaging device 15 as the cutting data.

Note that the control panel 800 is not limited to a control panel designed and manufactured as a device dedicated for controlling the sheet cutting unit 100, and the control panel 800 may cause a general purpose computer such as a personal computer to execute a computer-readable control program. The plural functions illustrated in plural blocks in the control panel 800 of FIG. 2 may also be provided by one hardware. For example, the function of the processor 801 and the function of the storage unit 802 may also be provided by an integrated circuit device such as an FPGA (Field Programmable Gate Array), an ASIC (Application Specific Integrated Circuit), or the like. Further, the function indicative of one block in the control panel 800 of FIG. 2 may be provided by plural separate pieces of hardware. For example, the function of the storage unit 802 can be provided by the ROM, the RAM, and an auxiliary storage device such as the HDD as described above. Further, the number of processors to provide the functionality of the processor 801 may be two or more.

When the object 11 to be cut is cut by the cutting device 1 described above, the position of the holding member 2 in the Y-direction and the position of the carriage 4 in the X-direction are first controlled so that the blade edge 301 of the cutter 3 comes above a cutting start position on the top surface of the object 11 to be cut as illustrated in FIG. 3A. After that, the Z-direction moving mechanism 122 is driven by the third drive unit 7C to move the cutter 3 in such a manner that the blade edge 301 of the cutter 3 cuts into (sticks into) the object 11 to be cut until a target position ZT on the Z-direction negative side (downward) than an interface between the adhesive layer 210 of the holding member 2 and the object 11 to be cut. At this time, the third drive unit 7C applies, to the cutter 3 through the Z-direction moving mechanism 122, such a pressing force that the blade edge 301 of the cutter 3 cuts into (sticks into) the object 11 to be cut until the target position ZT. In other words, the third drive unit 7C and the Z-direction moving mechanism 122 can be a pressing force applying unit to apply the pressing force to the blade 300 of the cutter 3 in contact with the object 11 to be cut as described above.

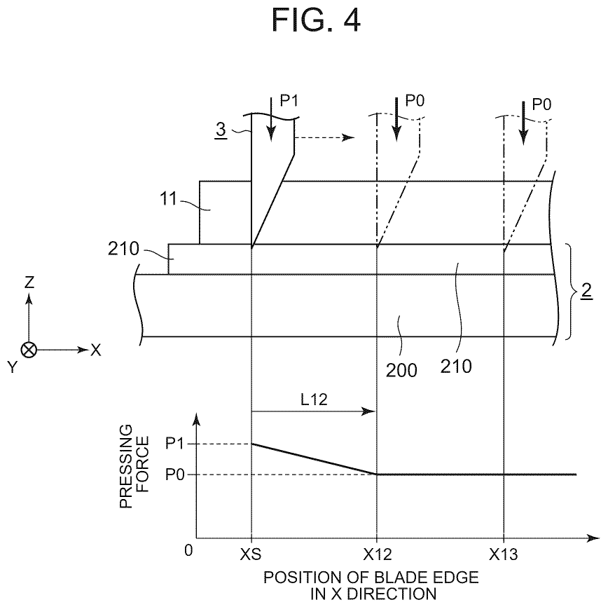

In the cutting device 1 of the present embodiment, after cutting into the object 11 to be cut by the initial pressing force P1 (>P0), the blade 300 of the cutter 3 makes progress of cutting until the position X12 moved by the distance L12 from the cutting start position XS while gradually reducing the pressing force from P1 to P0, and makes progress of cutting by the steady pressing force P0 from the position X12 to a cutting end position XE as illustrated in FIG. 4. When starting the progress of cutting in such a state that the initial pressing force P1 is applied to the cutter 3, a force to move the cutter 3 downward is generated, but the force is offset by a force to move the cutter 3 upward from the cutting start position XS to the position X11. Further, the occurrence of a cutting defect or the like by moving the blade edge 301 of the cutter 3 downward due to a difference between the initial pressing force P1 and the steady pressing force P0 can be suppressed by gradually reducing the pressing force applied to the cutter 3 from P1 to P0.

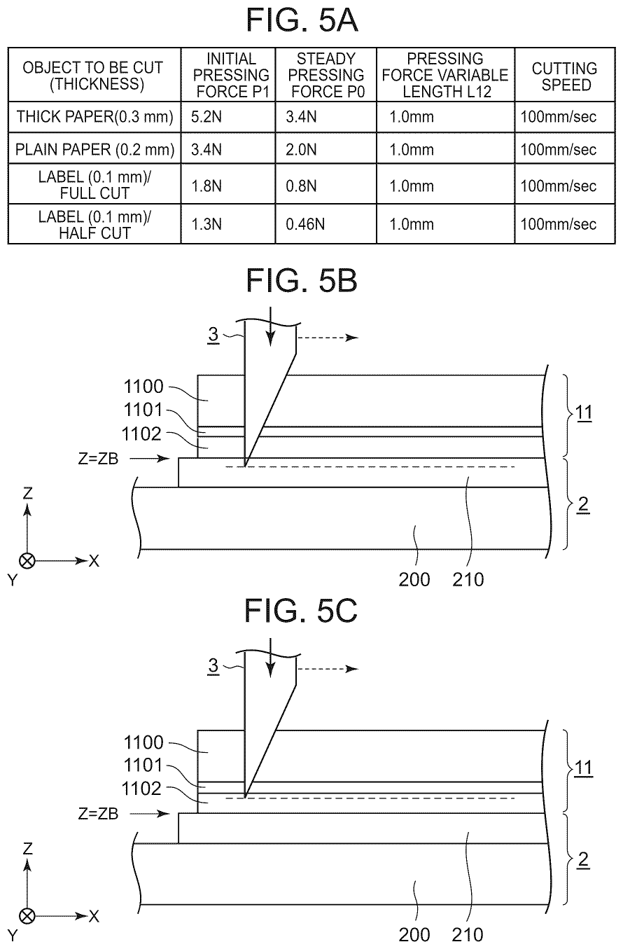

Note that an appropriate combination of the initial pressing force P1 and the steady pressing force P0 varies depending on the thickness and composition of the object 11 to be cut. In a table of FIG. 5A, combinations of initial pressing forces P1 and steady pressing forces P0 for some objects 11 to be cut are illustrated. Labels in the table of FIG. 5A can exemplify a multi-layered object 11 to be cut as illustrated in FIG. 5B, in which an adhesive layer 1101 and a release paper 1102 are laminated and arranged on the bottom surface of a base material 1100. The base material 1100 may be a paper, a resin sheet, or the like, and printing is possible on the top surface thereof by an inkjet printer, a laser printer, or the like. The illustrated object 11 to be cut can be pasted as an adhesive sheet on desired goods by peeling off the release paper 1102. When cutting this type of object 11 to be cut by the cutting device 1, it may be possible to select, for example, between a process of cutting all of the base material 1100, the adhesive layer 1101, and the release paper 1102 as illustrated in FIG. 5B (full-cut process), and a process of cutting only the base material 1100 and the adhesive layer 1101 as illustrated in FIG. 5C (half-cut process). Further, in the table of FIG. 5A, a pressing force variable length L12 and a cutting speed for each object 11 to be cut are illustrated. The pressing force variable length L12 can be a distance from the cutting start position XS to the position X12 at which the pressing force becomes the steady pressing force P0 in a cutting path set for the object 11 to be cut. Note that the values illustrated in the table of FIG. 5A are just an example, and values different from the illustrated values may also be set. Information illustrated in the table of FIG. 5A is stored in the storage unit 802 of the control panel 8, read by the processor 801 of the control panel 8, for example, when an operator (worker) of the cutting device 1 specifies the type of object 11 to be cut, and used for controlling the pressing force applying unit (third drive unit 7C).

An example of cutting processing of the object 11 to be cut by the cutting device 1 of the present embodiment including control of a pressing force to be applied to the cutter 3 described above will be described with reference to FIG. 6. The cutting device 1 first performs initialization including a process of moving the position of the holding member 2 and the position of the cutter 3 to initial positions (home positions) (step S1). Specifically, the processor 801 of the control panel 8 transmits a control signal to each of the first drive unit 7A, the second drive unit 7B, and the third drive unit 7C, respectively. For example, the initialization in step S1 may also include a process of reading setting information on the type (thick paper, plain paper, label, or the like) and the size of each object 11 to be cut, position information of the object 11 to be cut on the top surface of the holding member 2, cutting data, and the like. After step S1, the processor 801 of the control panel 8 accesses the storage unit 802 to acquire control parameters according to the type of object 11 to be cut (step S2). In step S2, for example, the processor 801 acquires, as control parameters, the initial pressing force P1, the steady pressing force P0, the pressing force variable length L12, the cutting speed, and the like illustrated in the table of FIG. 5A.

Next, the cutting device 1 moves the object 11 to be cut (the holding member 2) and the cutter 3 to the cutting start position to adjust the blade edge of the cutter 3 (step S3). Consecutively, the cutting device 1 makes the blade 300 of the cutter 3 cut into the object 11 to be cut by the initial pressing force P1 (step S4). In step S3, the processor 801 of the control panel 8 identifies the position of the holding member 2 in the Y direction at which the blade edge 301 of the cutter 3 is placed above the cutting start position on the top surface of the object 11 to be cut as illustrated in FIG. 3A, and the position of the carriage 4 in the X direction based on the cutting data. After that, based on differences between the identified positions and the current positions of the holding member 2 in the Y direction and the carriage 4 in the X direction, the processor 801 drives the first drive unit 7A and the second drive unit 7B to move the object 11 to be cut (the holding member 2) and the cutter 3 to the cutting start position. Further, in step S3, the processor 801 adjusts the blade edge to direct the blade 300 of the cutter 3 to a cutting direction derived based on the cutting data. In step S4, the processor 801 drives the third drive unit 7C to make the blade 300 of the cutter 3 cut into (stuck into) the object 11 to be cut by the initial pressing force P1.

After step S4, the cutting device 1 makes progress of cutting the object 11 to be cut by changing the position of the blade 300 of the cutter 3 relative to the object 11 to be cut while reducing the pressing force applied to the cutter 3 (step S5). In step S5, for example, based on a relationship between the amount of change (moving distance) in the position of the blade edge 301 of the cutter 3 on the top surface of the object 11 to be cut in plan view and the pressing force derived from the control parameters acquired in step S2 (see FIG. 4), the processor 801 of the control panel 8 drives the third drive unit 7C to reduce the pressing force to be applied to the cutter 3. Further, in step S5, the processor 801 drives the first drive unit 7A and the second drive unit 7B based on the cutting data to control the position of the holding member 2 in the Y direction and the position of the blade edge 301 of the cutter 3 in the X direction in order to change the position of the blade 300 of the cutter 3 relative to the object 11 to be cut. The processor 801 performs the process in step S5 until the pressing force of the cutter 3 reaches the steady pressing force P0 or until the moving distance of the blade edge 301 of the cutter 3 becomes more than the pressing force variable length L12 (step S6: NO).

When the pressing force of the cutter 3 reaches the steady pressing force P0 or when the moving distance of the blade edge 301 of the cutter 3 becomes equal to or more than the pressing force variable length L12 (step S6: YES), the processor 801 changes the position of the blade 300 of the cutter 3 relative to the object 11 to be cut in such a state that the steady pressing force P0 is applied to the cutter 3 to make progress of cutting the object 11 to be cut (step S7). In step S7, the processor 801 controls the operation of the third drive unit 7C to drive the Z-direction moving mechanism 122 of the carriage moving mechanism 120 in order not to change the position of the blade edge 301 of the cutter 3 in the Z direction. The processor 801 performs the process in step S7 until the blade edge 301 of the cutter 3 reaches the cutting end position (step S8: NO). When the blade edge 301 of the cutter 3 reaches the cutting end position (step S8: YES), the processor 801 ends the process in step S7 for making the progress of cutting the object 11 to be cut by the steady pressing force P0, and determines the presence or absence of a cutting path in which cutting is not completed yet (step S9). When determining that there is no cutting path in which cutting is not completed yet (step S9: NO), the processor 801 pulls out the blade 300 of the cutter 3 from the object 11 to be cut, moves the holding member 2 and the cutter 3 to the initial position (home position) (step S13), and ends the cutting processing.

When determining that there is a cutting path in which cutting is not completed yet (step S9: YES), the processor 801 determines whether or not it is possible to continue cutting based on the cutting data (step S10). In step S10, the processor 801 determines whether or not it is possible to continue cutting of the object 11 to be cut without pulling out the blade 300 of the cutter 3 from the object 11 to be cut. In other words, the meaning of “to continue cutting” in step S10 is intended to further make progress of cutting the object 11 to be cut by the blade 300 of the cutter 3 using the current cutting end position as a cutting start position of the cutting path in which cutting is not completed yet. When it is possible to continue cutting (step S10: YES), the processor 801 adjusts the blade edge to change the direction of the blade 300 of the cutter 3 to a cutting direction when making progress of cutting the object 11 to be cut using the current cutting end position as the next cutting start position (step S11). After that, the processes in step S7 and subsequent steps are performed in the cutting device 1. When it is impossible to continue cutting (step S10: NO), the processor 801 pulls out the blade 300 of the cutter 3 from the object 11 to be cut (step S12). After that, the processes in step S3 and subsequent steps are performed in the cutting device 1.

Note that the cutting processing described above with reference to FIG. 6 is just an example of cutting processing executable in the cutting device 1 of the present embodiment. For example, the cutting processing in the cutting device 1 of the present embodiment can be changed according to the configuration of the holding member moving mechanism 110, the X-direction moving mechanism 121 and the Z-direction moving mechanism 122 of the carriage moving mechanism 120, and the like. Further, the cutting processing in the cutting device 1 of the present embodiment can be changed according to the procedure of cutting the object 11 to be cut based on the cutting data, and the like. For example, the processes from step S5 to step S9 illustrated in FIG. 6 may be changed according to the length of the cutting path subjected to cutting and a size relationship with the pressing force variable length L12 illustrated in FIG. 5A. For example, when perforating the object 11 to be cut, the length of one cutting path becomes shorter than the pressing force variable length L12 (for example, 1.0 mm) so that the blade edge 301 of the cutter 3 may reach the cutting end position before the pressing force of the cutter 3 becomes the steady pressing force P0 and before the moving distance of the blade edge 301 becomes the pressing force variable length L12. Therefore, when the length of one cutting path subjected to cutting is shorter than the pressing force variable length L12 (for example, 1.0 mm), the cutting processing performed by the cutting device 1 may perform the determination in step S9 at the time when the blade edge 301 of the cutter 3 reaches the cutting end position. Further, for example, when continuing cutting using the cutting end position as the next cutting start position, the procedure may return to step S4 after adjusting the blade edge in step S11 to change the pressing force from the steady pressing force P0 to the initial pressing force P1 (>P0). Further, the process illustrated in one block of the flowchart of FIG. 6 may be performed as two or more processes, or the processes illustrated in two or more blocks may be performed as one integrated process.

As described above, in the cutting device 1 of the present embodiment, when the blade 300 of the cutter 3 is cut into the object 11 to be cut, the pressing force (initial pressing force P1) applied to the cutter 3 is made greater than a pressing force (steady pressing force P0) required to make progress of cutting the object 11 to be cut by the blade 300 of the cutter 3. Therefore, a cutting defect due to an insufficient biting amount of the blade 300 of the cutter 3 at the cutting start position of the object 11 to be cut (due to the fact that the Z-direction position of the blade edge 301 does not reach the target position ZT) can be prevented. Further, the third drive unit 7C as the pressing force applying unit to apply the pressing force to the cutter 3 when making progress of cutting the object 11 to be cut is so controlled that the pressing force applied to the cutter 3 when the cutter 3 is moved by a predetermined distance L12 after the blade 300 of the cutter 3 is cut into the object 11 to be cut by the initial pressing force P1 is set to the steady pressing force P0 less than the initial pressing force P1. In other words, the processor 801 controls the third drive unit 7C so that the pressing force applied to the cutter 3 by the third drive unit 7C (pressing force applying unit) is reduced along with a change in the position of the blade 300 of the cutter 3 relative to the object 11 to be cut by the predetermined distance is changed after the pressing force is applied to the cutter 3. Therefore, a cutting defect due to the fact that the biting amount of the blade 300 of the cutter 3 when making progress of cutting the object 11 to be cut from the cutting start position varies can be prevented. Specifically, for example, a cutting defect to cut a layer undesired to be cut in the multi-layered object 11 to be cut due to a change that increases the biting amount of the blade 300 of the cutter 3 by making progress of cutting the object 11 to be cut in a state where the initial pressing force P1 larger than the steady pressing force P0 is applied to the cutter 3 can be prevented. Further, for example, such a cutting defect that the cutting is incomplete due to an insufficient biting amount as a result of a change that reduces the biting amount of the blade 300 of the cutter 3 by making progress of cutting the object 11 to be cut after the pressing force applied to the cutter 3 at the cutting start position is reduced from the initial pressing force P1 to the steady pressing force P0 can be prevented. Especially, as described above with reference to FIG. 4, the variation range of the biting amount of the blade 300 of the cutter 3 can be reduced by making progress of cutting while gradually reducing the pressing force applied to the cutter 3 from the cutting start position to the position X12 at which the pressing force becomes the steady pressing force P0, and hence the progress of cutting the object 11 to be cut can be made stably from the cutting start position.

Further, in the embodiment described above, the pressing force applied to the cutter 3 when the cutter 3 is moved by the predetermined distance L12 relative to the object 11 to be cut after the blade 300 of the cutter 3 is cut into the object 11 to be cut at the cutting start position is controlled to the steady pressing force P0. However, the cutting device 1 of the present embodiment is not limited to this control. For example, the pressing force applied to the cutter 3 when the cutter 3 is moved for a predetermined time relative to the object 11 to be cut after the blade 300 of the cutter 3 is cut into the object 11 to be cut at the cutting start position may be controlled to the steady pressing force P0. For example, when the cutting path on the top surface of the object 11 to be cut in plan view is a straight line, the position X12 at which the pressing force applied to the cutter 3 from the cutting start position XS illustrated in FIG. 4 is changed to the steady pressing force P0 can be easily derived. However, when the cutting path on the top surface of the object 11 to be cut in plan view contains a curve(s), it may be difficult to derive the position X12 moved by the distance L12 from the cutting start position XS. In contrast to this case, the timing of changing the pressing force applied to the cutter 3 to the steady pressing force P0 is identified by deriving the time required to move the blade edge 301 of the cutter 3 by the distance L12 from the cutting start position XS based, for example, on the pressing force variable length L12 and the cutting speed illustrated in FIG. 5A. Therefore, the pressing force applied to the cutter 3 at an appropriate position X12 can be controlled to the steady pressing force P0 regardless of the cutting path from the cutting start position XS to the cutting end position XE.

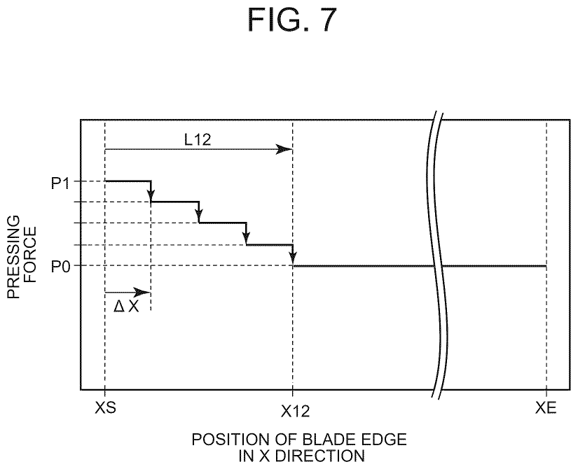

In the cutting device 1 of the present embodiment, the control of gradually reducing the pressing force applied to the cutter 3 in the cutting path from the cutting start position XS to the position X12 is not limited to linear control of reducing the pressing force in proportion to the distance from the cutting start position XS, and it may also be nonlinear control. As illustrated in FIG. 7, the pressing force applied to the cutter 3 in the cutting path from the cutting start position XS to the position X12 may be controlled to be reduced step by step every time the cutter 3 makes progress of cutting by a predetermined distance ΔX. Further, the pressing force applied to the cutter 3 in the cutting path from the cutting start position XS to the position X12 may be controlled to be represented by a monotonically decreasing curve.

The embodiment described above illustrates a specific example to facilitate the understanding of the present invention, and the present invention is not limited to the embodiment described above. In the cutting device, the cutting method, and the recording medium, various modifications and changes are possible without departing from the scope and sprit of the appended claims.

What is claimed is:

1. A cutting device comprising:
a holding member which holds a sheet-shaped object to be cut;
a cutter which cuts the object to be cut by changing a position of a blade relative to the object to be cut along the object to be cut in such a state that the blade is cut into the object to be cut;
a pressing force applying unit which applies a pressing force to the cutter in contact with the object to be cut;
a relative position changing unit which changes the position of the blade of the cutter relative to the object to be cut held by the holding member; and
a processor which controls the pressing force applying unit to reduce the pressing force applied to the cutter by the pressing force applying unit along with a change in the position of the blade of the cutter relative to the object to be cut by a predetermined distance or for a predetermined time after the pressing force is applied to the cutter.

2. The cutting device according to claim 1, wherein
at least one cutting path for cutting the object to be cut by the cutter is set, and
the processor controls the pressing force applying unit in such a manner that
a first pressing force is applied to the blade of the cutter that is cut into the object to be cut at a start of cutting along the cutting path, and
when changing the position of the blade of the cutter relative to the object to be cut by the predetermined distance or for the predetermined time after the blade of the cutter is cut into the object to be cut, a second pressing force smaller than the first pressing force is applied to the cutter.

3. The cutting device according to claim 1, wherein the processor controls the pressing force applying unit in such a manner that the pressing force applied to the cutter in a cutting section from a first position to a second position in the cutting path set for the object to be cut monotonically decreases depending on a distance from the first position or an elapsed time after a start of moving from the first position to the second position.

4. A cutting method causing a processor for controlling operation of a cutting device including a holding member which holds a sheet-shaped object to be cut, and a cutter which cuts the object to be cut, the control method comprising:
a first step of applying a pressing force to the cutter in contact with the object to be cut held by the holding member to make a blade of the cutter cut into the object to be cut; and
a second step of cutting the object to be cut by changing a position of the blade of the cutter cut into the object to be cut relative to the object to be cut,
wherein in the second step, the pressing force applied to the cutter is controlled to be reduced along with a change in the position of the blade of the cutter relative to the object to be cut by a predetermined distance or for a predetermined time after the pressing force is applied to the cutter in the first step.

5. A non-transitory computer readable recording medium on which a program executable by a processor for controlling operation of a cutting device including a holding member which holds a sheet-shaped object to be cut, and a cutter which cuts the object to be cut is recorded, the program causing the processor to execute the following processes of:
a first step of applying a pressing force to the cutter in contact with the object to be cut held by the holding member to make a blade of the cutter cut into the object to be cut; and
a second step of cutting the object to be cut by changing a position of the blade of the cutter cut into the object to be cut relative to the object to be cut,
wherein in the second step, the pressing force applied to the cutter is controlled to be reduced along with a change in the position of the blade of the cutter relative to the object to be cut by a predetermined distance or for a predetermined time after the pressing force is applied to the cutter in the first step.
